(19) United States
(12) Patent Application Publication
(10) Pub. No.: US 2016/0358285 A1
(43) Pub. Date: Dec. 8, 2016

(54) AUTOMATED PROVIDER CLAIMS SUMMARY SYSTEM AND METHOD

(71) Applicants: Timothy McClure, Louisville, KY (US); Gregory Hayworth, Louisville, KY (US)

(72) Inventors: Timothy McClure, Louisville, KY (US); Gregory Hayworth, Louisville, KY (US)

(73) Assignee: HUMANA INC., Louisville, KY (US)

(21) Appl. No.: 13/287,719

(22) Filed: Nov. 2, 2011

(51) Int. Cl. G06Q 40/08; G06Q 50/22

(52) U.S. Cl. CPC G06Q 50/22

(57) ABSTRACT

An automated system and method for calculating healthcare provider claims metrics and generating reports comprising claims metrics. The automated system and method facilitates provider claims analysis for providers that belong to a healthcare system or network. A computer user enters identifying information for a healthcare provider (such as a tax identification number). The healthcare provider identifying information may be used to generate a report for the individual provider and a system report for the system or network to which the provider belongs. Each report comprises a plurality of metrics related to claims processed for the provider by a healthcare benefits company. The report provides numerous metrics and details regarding the claims processed by the healthcare benefits company. By reviewing the data and additional processing tips, the healthcare provider may identify ways to increase the number of successfully processed claims in a particular time period and to improve its business operations.

### FIELD OF THE INVENTION

The present invention relates to automated document generation. In particular, the present invention relates to automated system and method for generating a healthcare provider claims summary.

### BACKGROUND OF THE INVENTION

Providers of medical and health services typically rely on third-party insurers to receive payment for the services they provide to patients. The payment process typically involves submission of a claim from the provider to the insurer requesting a payment, adjudication of the claim by the insurer to determine a level of payment, and remittance of a payment from the insurer to the provider according to the adjudicated claim. High volume providers may submit numerous claims each month to many different insurers to receive payments for the services they provide to their patients.

The amount paid by each insurer to the provider for each service depends upon various factors including the level of insurance coverage for specified medical services and products. Many insurers offer numerous insurance plans to consumers and therefore, provide varying levels of coverage. As a result, the provider's payment for the same procedure performed on two different patients may vary according to the coverage under each patient's insurance plan.

In addition to offering different types of insurance plans and levels of coverage, every insurer typically establishes its own criteria for completing and submitting claims. The criteria related to the content of a claim as well as the submission process may be stringent. The insurer may decline claims that fail to meet its specific criteria for content and submission. When the claim is declined, the provider must correct the deficiency or deficiencies in the claim and resubmit it. Every rejection of the claim from the insurer delays the payment and increases the provider's administrative costs.

Because the provider may interact with numerous insurers offering numerous plans and levels of coverage as well as claims submission requirements, it can be difficult for the provider to determine the extent of its interactions with each insurer. For example, the provider may not know the number of claims it processes each month with each insurer, the “success rate” for claims, the “decline rate” for claims, or the amounts paid by the insurer. Such information, however, may be of great value to the provider. Claims processing “metrics” may allow the provider to determine its administrative or overhead costs and more importantly, assist the provider in reducing its administrative or overhead costs with a particular insurer. The ability to compare metrics over a period a time may further assist the provider in determining which cost reduction efforts are effective. A reduction in administrative overhead and costs may allow the provider to devote more time and resources to patient care.

Although administrative metrics for claims may be useful to a provider, obtaining such metrics can be difficult. The provider may have the information it needs to calculate the metrics but the required data may not be centrally located or readily accessible. Furthermore, the provider may not have the knowledge or tools to calculate the metrics. By devoting time and resources to the effort, the data collection and calculation processes further increase the provider's administrative costs and burden.

For providers that operate multiple facilities or that are part of an extensive health network, collecting claims data across facilities and calculating the metrics can be particularly challenging. The provider may not know how or where all of the information it needs to calculate metrics across facilities is stored. In addition, the provider is unlikely to have any tools to facilitate the data collection and analysis or to even understand, once the data has been collected, how the calculations should be performed. There is a need for an automated system and method for calculating provider claims metrics and generating reports comprising provider claims metrics. There is a need for an automated system and method for calculating provider claims metrics for providers that are part of a health care system or network.

### SUMMARY OF THE INVENTION

The present disclosure describes an automated system and method for calculating provider claims metrics and generating reports comprising provider claims metrics. The automated system and method facilitates provider claims analysis for providers that belong to a healthcare system or network. In an example embodiment, a computer user enters identifying information for a healthcare provider (such as a tax identification number (TIN)). The healthcare provider identifying information may be used to generate a report for the individual provider and a system report for the system or network to which the provider belongs. TINs may be linked using a system generated identifier.

Reports are generated based on TINs or other provider identifiers selected by a computer user. Reports may be generated for individual providers or for an entire system or network. Each report comprises a plurality of metrics related to claims processed for the provider by a healthcare benefits company or insurer. The report provides numerous metrics and details regarding the claims processed by the healthcare benefits company. By reviewing the data and additional processing tips from the healthcare benefits company, the provider may identify ways to increase the number of successfully processed claims in a particular time period and to improve its business operations.

### BRIEF DESCRIPTION OF THE DRAWINGS

FIG. 1A is a diagram of a daily claims data process according to an example embodiment;

FIG. 1B is a diagram of a daily non-claims data process according to an example embodiment;

FIG. 2A is a sample taxpayer identification number (TIN) document type page according to an example embodiment;

FIG. 2B is a sample name document type page according to an example embodiment;

FIG. 2C is a sample summary by name report list page according to an example embodiment;

FIG. 3A is a sample claims summary report page according to an example embodiment;

FIG. 3B is a sample claims details report page according to an example embodiment;

FIG. 3C is a sample reprocessed claims report page according to an example embodiment; and

FIG. 3D is a sample inquiries report page according to an example embodiment.

### DETAILED DESCRIPTION

In an example embodiment, data for provider claim metrics may be located in a plurality of computer systems that support claims processing for numerous providers. Example computer systems are identified in Table 1.

TABLE 1
Computer Systems

| | | |
|---|---|---|
| Claims | CAS | Claims and subscriber management system that |
| Administration | | contains information on members, providers, |
| System | | and group benefits. |
| Contract | CIS | System for administering provider contracts. |
| Information | | |
| System | | |
| Enterprise Data | EDW | Repository for processed claims. |
| Warehouse | | |
| Interactive | IVR | Automated information verification line. |
| Voice Response | | |
| Program Benefits | PBA | System for administering program benefits for |
| Administration | | healthcare benefit companies. |
| Provider Cross | PCR | System for administering provider details and |
| Reference | | relationships. A provider system or network |
| | | may comprise a plurality of TINs that are |
| | | maintained in one or more tables and associated |
| | | with a system generated identifier. |
| Health | HIN | System for managing health information |
| Information | | records and processing EDI transactions. |
| Network | | |

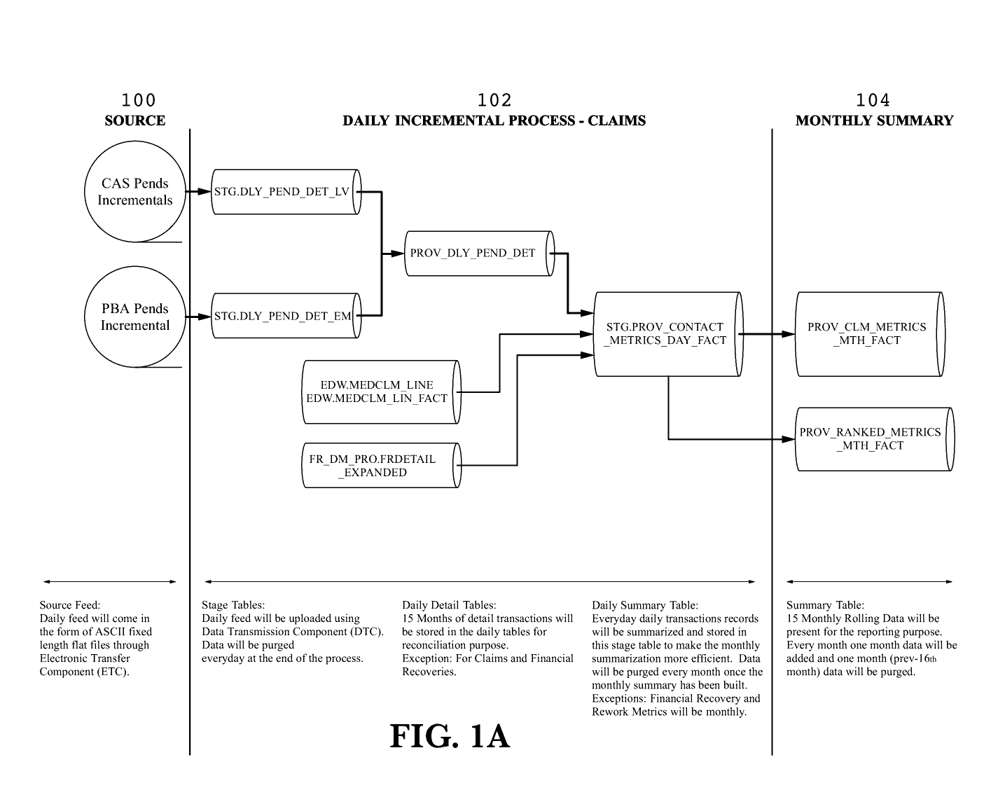

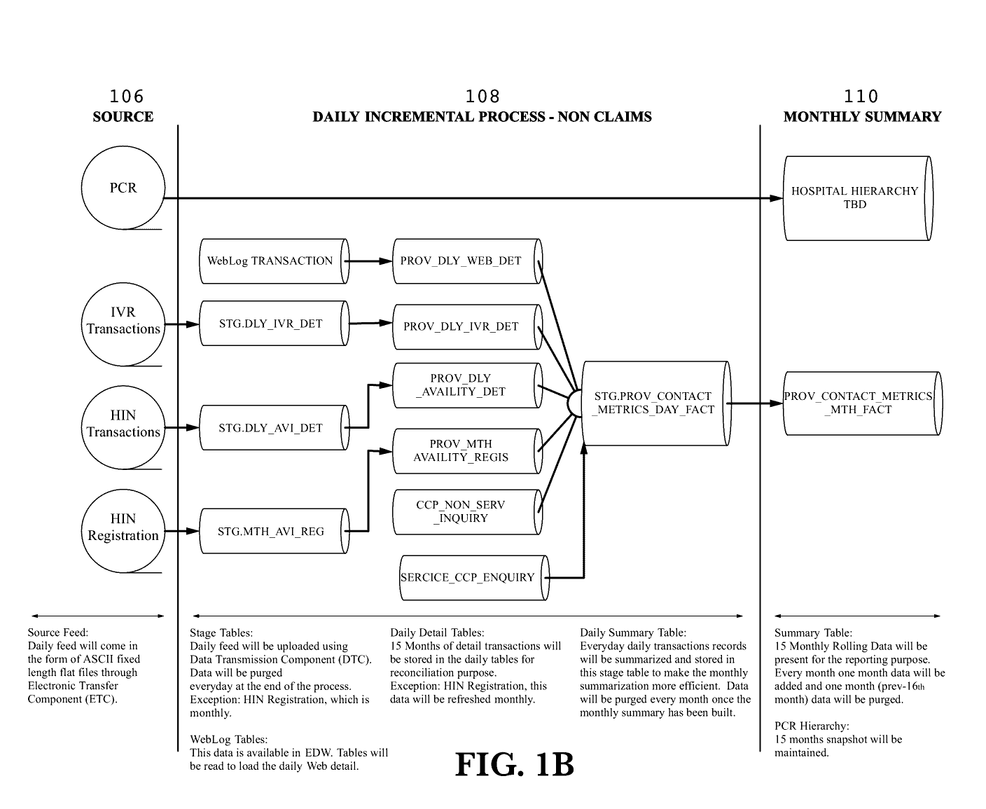

Claims data as well as non-claims data relevant to the healthcare providers and their business operations is aggregated to facilitate generation of reports for a specified time period. The relevant data may relate to medical claims as well as financials, authorizations, referrals, and customer inquiries. Data from different provider offices or facilities is linked to provide the provider with a comprehensive clinical overview of its claim data. Referring to FIG. 1A, a daily claims data process according to an example embodiment is shown. In an example embodiment, the process comprises a source phase 100, a daily incremental phase 102, and a monthly summary phase 104. Source feeds 100 include pending claims from the CAS and PBA systems. A data transformation component receives files (e.g., ASCII flat files) through an electronic transfer component. In the daily incremental phase 102, files are uploaded to a data transformation component. The data transformation component reads the file and loads it into one or more stage tables. From stage tables, daily detail tables are populated. Fifteen months of detail transactions may be stored in daily detail tables for reconciliation purposes. A daily summarization operation is performed and daily summary tables are populated to make monthly summarization more efficient. Monthly summarization is a snapshot of data per reporting month. To facilitate report generation, data may held in a monthly summarization table for 15 months. After 15 months, a month's data is purged from the table. In stage data may be purged as defined below:

TABLE 2
Data Purges

| | |
|---|---|
| Daily Stage | Daily after successful completion of data load of |
| | external feeds. |
| Daily Summary | At the end of the month and monthly snapshot is |
| | over with the success flag. |

In an example embodiment, reports may be generated in the monthly summary phase 104. A summary table may comprise 15 months of rolling data. Reports may alternatively be generated each calendar quarter and include data relevant for that quarter.

Referring to FIG. 1B, a daily non-claims data process according to an example embodiment is shown. In an example embodiment, the process comprises a source phase 106, a daily incremental phase 108, and a monthly summary phase 110. Alternatively, the summary phase may occur quarterly. Source feeds 106 include cross-reference data from the PCR system, IVR transaction data, and HIN system transactions and registrations. A data transformation component receives files (e.g., ASCII flat files) through an electronic transfer component. In the daily incremental phase 108, files are uploaded to a data transformation component. The data transformation component reads the file and loads it into one or more stage tables and weblog tables. From stage tables, daily detail tables are populated. Fifteen months of detail transactions may be stored in daily detail tables for reconciliation purposes. A daily summarization operation is performed and daily summary tables are populated to make monthly summarization more efficient. Monthly summarization is a snapshot of data per reporting month. To facilitate report generation, data may held in a monthly summarization table for 15 months. After 15 months, a month's data is purged from the table. In stage data may be purged as defined below:

TABLE 3
Data Purges

| | |
|---|---|
| Daily Stage | Daily after successful completion of data load of |
| | external feeds. |
| Daily Summary | At the end of the month and monthly snapshot is |
| | over with the success flag. |

Reports are generated in the monthly summary phase 110. A summary table may comprise 15 months of rolling data. A PCR hierarchy table also comprises 15 months of data.

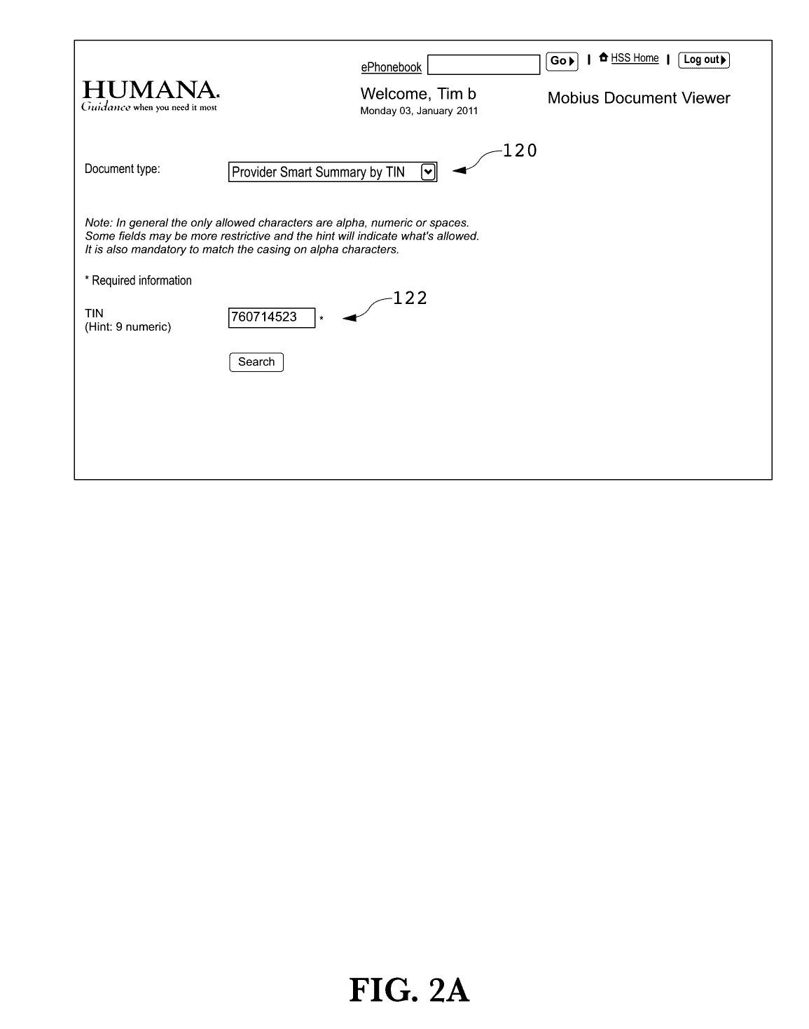

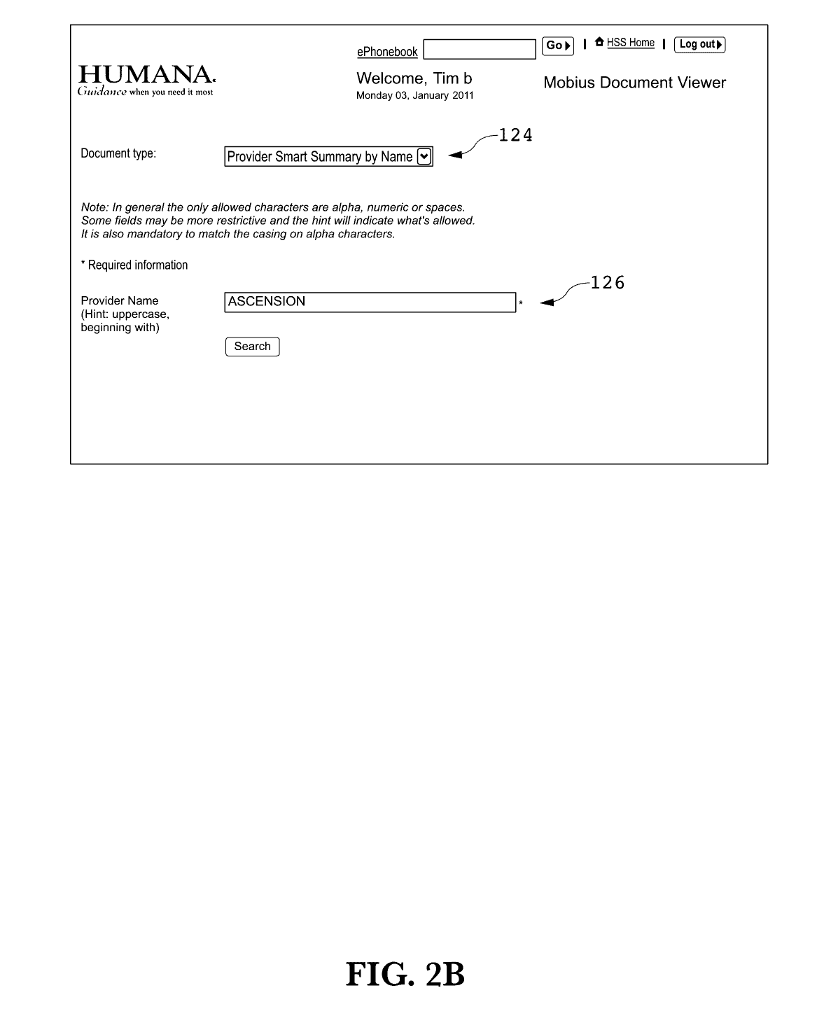

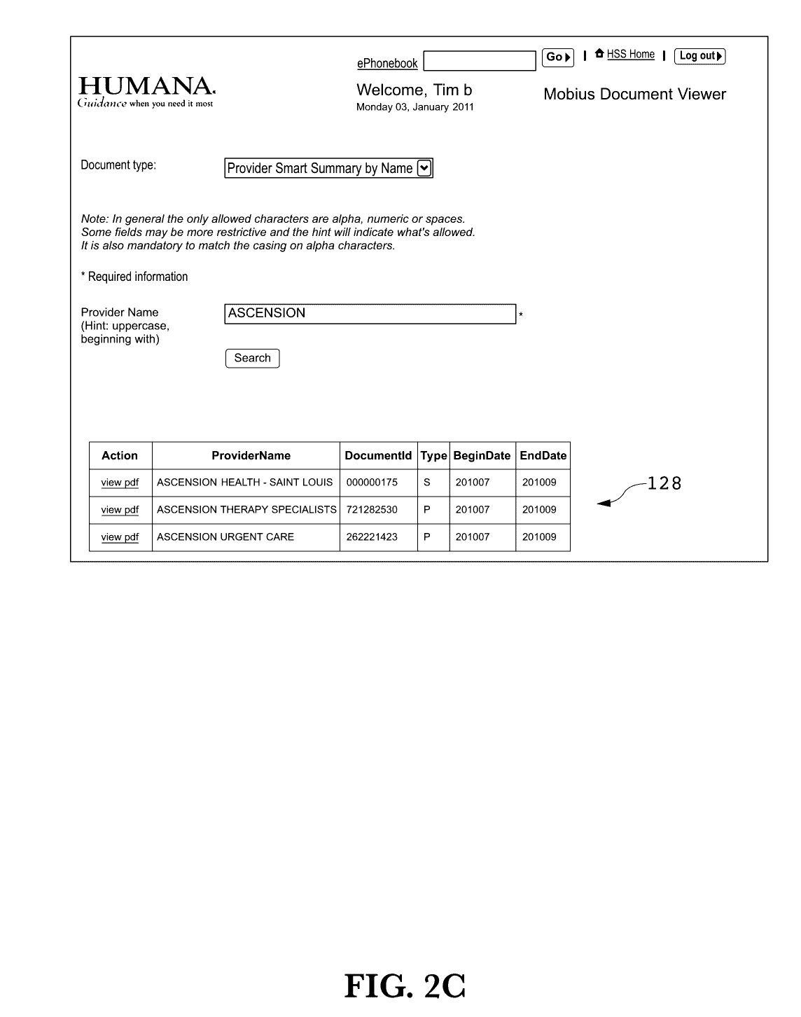

Referring to FIG. 2A, a sample taxpayer identification number (TIN) document type page according to an example embodiment is shown. A computer user may select a document type of summary by TIN option 120 and then enter a TIN 122 to identify a provider. Referring to FIG. 2B, a sample name document type page according to an example embodiment is shown. A computer user may select a document type of summary by name option 124 and then enter the name of a provider 126.

Referring to FIG. 2C, a sample summary by name report list page according to an example embodiment is shown. The page comprises a table 128 with the information identified in Table 4.

TABLE 4
Report List

| | |
|---|---|
| Action | Link to summary report |
| Provider Name | Entities associated with provider name or TIN |
| | specified by user |
| Document | For individual provider, TIN |
| Identifier | For provider system or network, system generated |
| | identifier |
| Type | S—system |
| | P—individual provider |
| Begin Date | Starting date for report |
| End Date | Ending date for report |

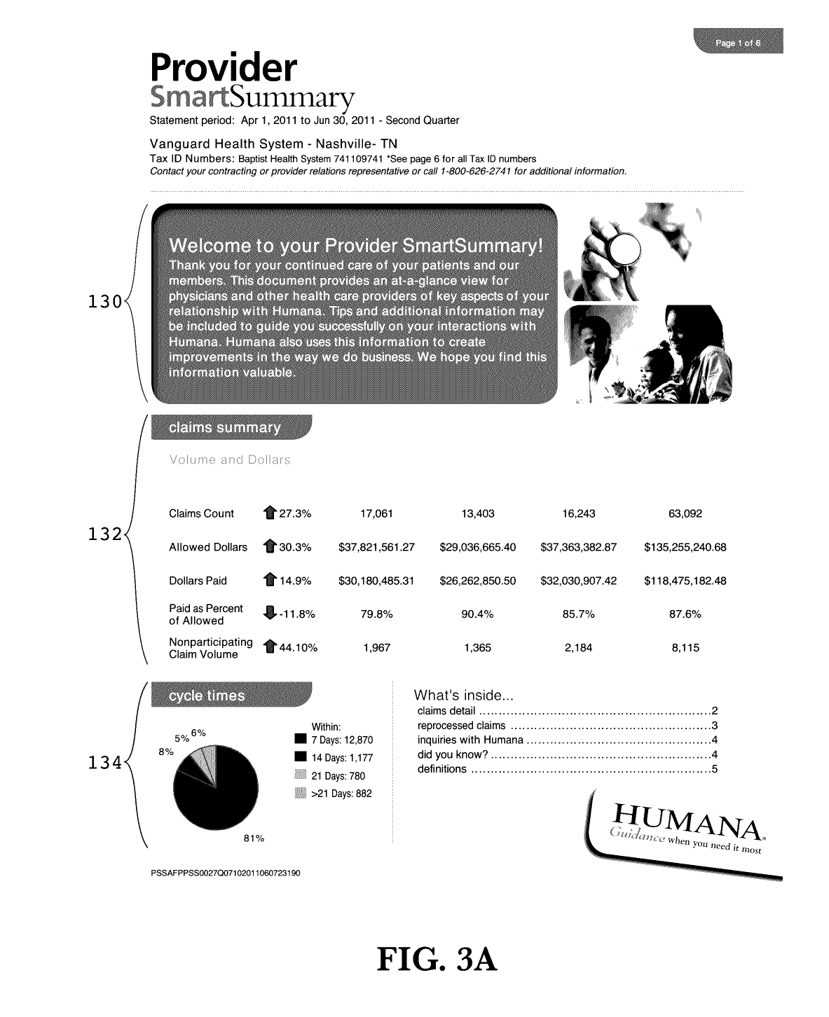

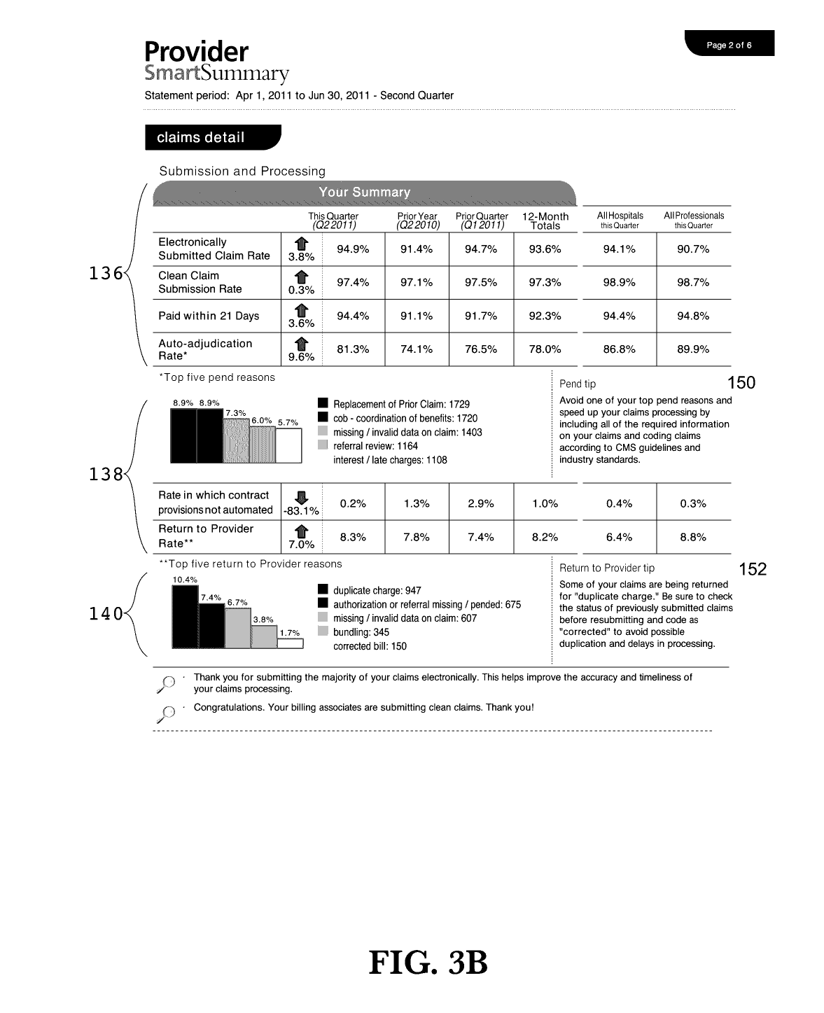

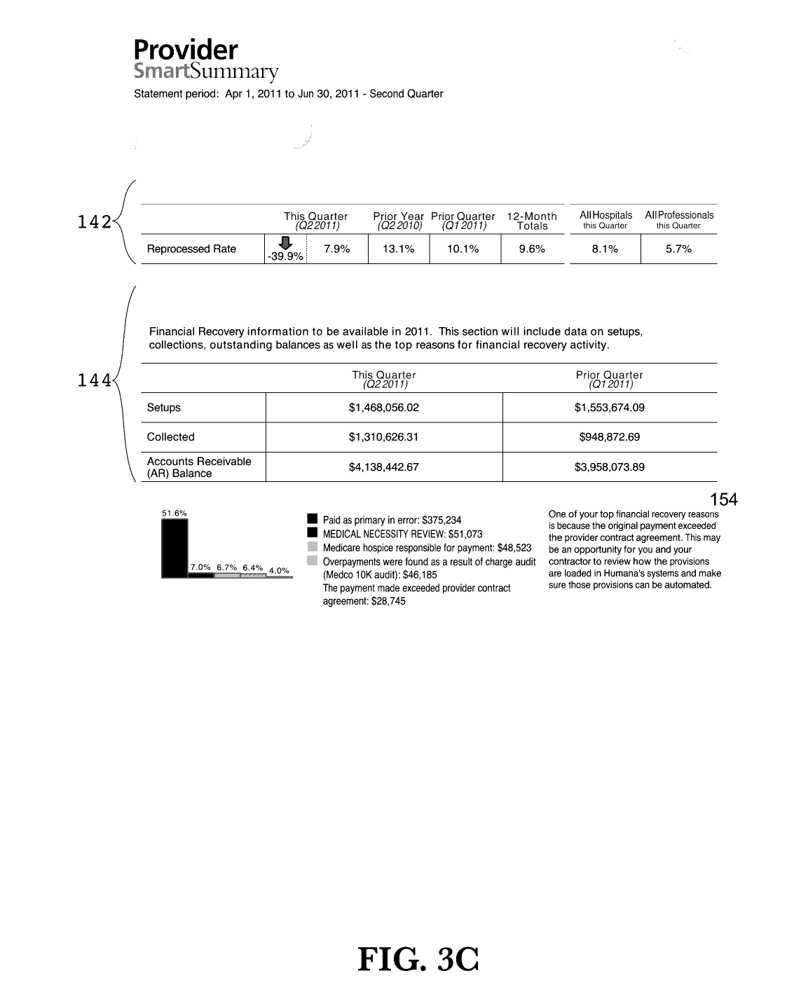

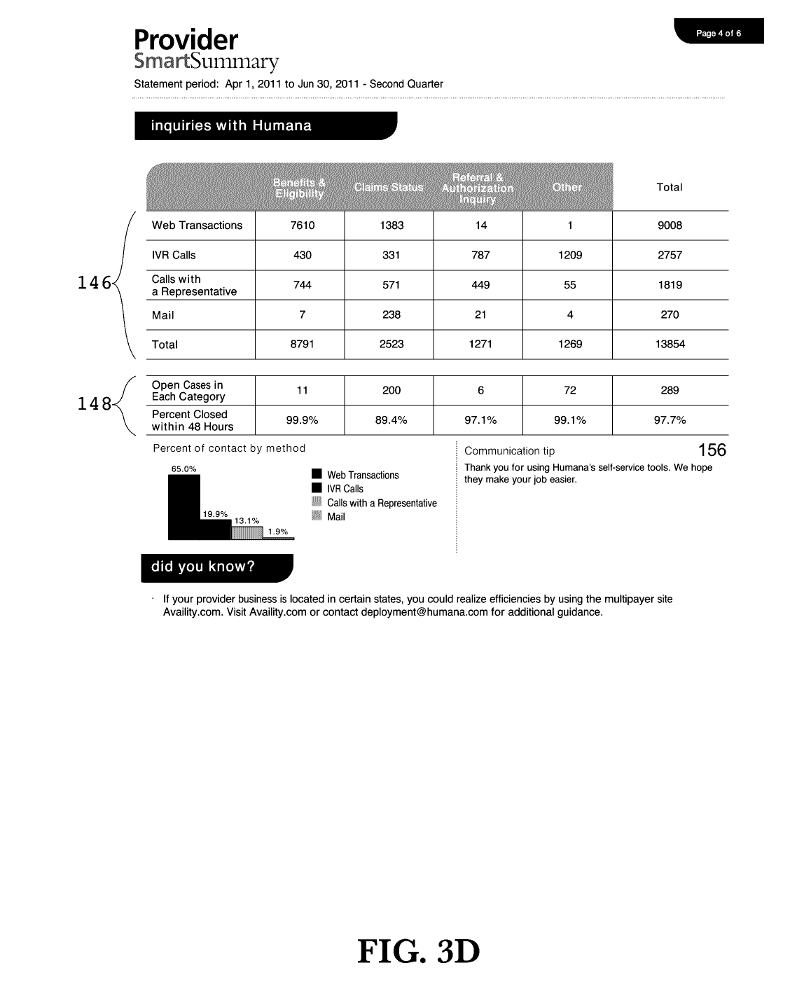

Referring to FIG. 3A, a sample claims summary report page according to an example embodiment is shown. The page comprises identifying information for the specified entity 130 and a claims summary section 132 that provides a plurality of metrics related to the provider's volume and dollar amounts. In an example embodiment, the claims volume and dollar metrics comprise: quarterly claims count; quarterly allowed dollars; quarterly paid as percent of allowed; and non-participating claim volume. Data for a current quarter, a prior quarter, the same quarter in the prior year and a 12-month view may be presented. The claims summary report page further comprises a graphical indicator of the healthcare benefit's company cycle time for claims. Metric definitions for the page are provided in Table 5.

TABLE 5
Claims Summary - Volume and Dollars

| | |
|---|---|
| Claims | Total number of adjudicated claims, paid or denied, |
| Count | during the period. Excludes any currently pended |
| | claims and those that have not been finalized. |
| | Represents the total complete claims (not individual |
| | line items on a claim). |
| Allowed | Dollars allowed (includes member responsibility) |
| Dollars | during the period. Excludes claims dollars processed |
| | as out-of-network and dollars paid direct to patient. |
| Dollars | Actual dollars paid from the healthcare benefits |
| Paid | company during the period. Excludes claims dollars |
| | processed as out-of-network and dollars paid direct to |
| | patient. |
| Paid as | Percent of dollars paid by healthcare benefits |
| Percent | company out of allowed dollars. |
| of Allowed | |
| Non- | Count of claims processed as out-of-network. |
| participating | |
| Claim Volume | |
| Cycle Times | Timeliness of the healthcare benefits company's |
| | adjudication of originally submitted claims (not |
| | including reprocessed claims). The determination |
| | is the difference between the receipt date and the |
| | check date or for denied claims, process date. |
| | Percentage of all claims and volume of claims |
| | processed within seven, 14, 21, or over 21 days. |

Referring to FIG. 3B, a sample claims details report page according to an example embodiment is shown. A claims details section 136 comprises a plurality of metrics related to the provider's submission and processing of claims. In an example embodiment the claims submission and processing metrics comprise: electronically submitted claim rate; initially accepted (clean) claim submission rate; paid within 21 days rate; auto-adjudication rate; rate in which contract provisions are not automated; and return to provider rate (denial rate). A “top reasons for pended claims” section 138 presents a graphical indicator of the number of claims that are pended and related reason codes (e.g., duplicate charge or financial recovery). The section further comprises a tip to the provider that may help the provider process claims more quickly. The tip may be based on a certain threshold that a certain metric reaches. The tip, which displays dynamically based on the specific provider's metrics, serves as an alert to a provider on a key metric and may further indicate an opportunity for the provider to improve and reduce processing delays such as days in accounts receivable. Another section identifies “top reasons for claims return” 140 and presents a tip to assist the provider in reducing claims returns. Metric definitions for the page are provided in Table 6.

TABLE 6
Claims Detail Submissions and Processing

| | |
|---|---|
| Electronically | Percentage of all claims submitted electronically |
| Submitted Claim | and processed during the period excluding any claims |
| Rate | rejected by clearinghouses or that did not reach |
| | the healthcare benefits company claims processing |
| | system through electronic means. |
| Clean Claim | Percentage of claims containing all required |
| Submission | data elements per regulatory and/or industry |
| Rate | guidelines that did not pend for reasons such |
| | as coordination of benefits, pre-existing, |
| | or subrogation. |
| Paid within | Percentage of originally submitted claims |
| 21 Days | processed within 21 days. |
| Auto- | Percentage of claims adjudicated without manual |
| adjudication | intervention through the healthcare benefit |
| Rate | company's claims processing system. |
| Pend Reasons | Top reasons that claim lines did not auto-adjudicate |
| | and percent each is of total pended lines (specific |
| | reasons that may display on remit notices are |
| | grouped by similar types of reasons on the report). |
| Rate in which | Percentage of claims in which the allowed amount |
| Contract | was manually calculated. |
| Provisions are | |
| Not Automated | |
| Return to | Percentage of claims adjudicated and completely |
| Provider Rate | denied; does not include claims in which certain |
| | lines are denied and other lines are paid. |
| Return to | Top reasons for claim denials (specific reasons |
| Provider | that may display on remit notices are grouped |
| Reasons | by similar types of reasons on this report). |

To facilitate report generation, pend and denial reasons may be maintained in a table in which similar codes and descriptions are associated. The use of a table obviates the need to display exact and lengthy HIPAA-compliant reason codes. Referring to FIG. 3C, a sample reprocessed claims report page according to an example embodiment is shown. In an example embodiment the page comprises a reprocessed rate 142 that indicates the percentage of claims that are reprocessed after initial adjudication. The page further comprises a financial recovery section 144 that indicates the provider's financial recovery for the quarter (amount collected during the quarter and balance due at the end for the quarter). Metric definitions for the page are provided in Tables 7A and 7B.

TABLE 7A
Reprocessed Claims - Reprocessing

| | |
|---|---|
| Reprocessed Rate | Percentage of claims reprocessed after initial |
| | adjudication. Each reprocessing of |
| | the same claim is included in the rate. |

TABLE 7B
Reprocessed Claims - Financial Recovery

| | |
|---|---|
| Setups | Dollar amount of claims identified as potential |
| | overpayments during the period. |
| Collected | Dollar amount healthcare benefits company |
| | collected during the period. |
| Accounts | Cumulative balance owed at the end of the report |
| Receivable (AR) | period (point in time). |
| Balance | |
| Top FR Reasons | Top reasons for overpayment setups. |

Referring to FIG. 3D, a sample inquiries report page according to an example embodiment is shown. An inquiries section 146 comprises a plurality of metrics related to the provider's inquires to the healthcare benefit company. The rows of the table indicate the computerized method of the inquiry (e.g., web transactions; IVR cases; calls with representatives; and mail) and the columns of the table indicate the category of inquiry (e.g., benefits and eligibility; claims status; referral and authorization inquiry; and other). A second section of the page 148 indicates the open cases in each category as of the end of the quarter or other reporting period and the percentage of cases closed within 48 hours. The details presented on the page assist the provider in understanding its usage of self-service options as compared to calls and mail. Metrics for the page are provided in Table 8.

TABLE 8
Inquiries

| | |
|---|---|
| Open Cases | Number of unresolved inquiries submitted by |
| in Each | phone or correspondence as of the last day of |
| Category | the reporting period. |
| Percent | Percentage of all inquiries submitted by phone |
| Closed within | or correspondence resolved within 48 hours |
| 48 hours | of receipt. |
| Percent of | Percentage of inquires for each inquiry method. |
| Contact by | |
| Method | |

Report Timing and Comparisons: In an example embodiment, summaries are available quarterly. Metrics and information (e.g., pends, returns-to-provider, and financial recovery reasons) reflect the specific quarter's experience for the provider. Quarterly metrics may be compared against the same quarter of the prior year, the prior quarter, and/or the 12 months ending with the quarter for the specific reporting period.

Report Benchmarks: Benchmarks for detail metrics relate to the healthcare benefits company's averages for hospital providers and professional providers and represent averages for the specific quarter's reporting period.

The disclosed automated system and method allows a computer user to generate and analyze claims metrics for numerous providers, including providers that are part of a network, through the selection of provider identifying data and report type. The ability to generate and analyze claims metrics facilitates process improvements by the provider and the opportunity to reduce administrative overhead and costs.

While certain embodiments of the present invention are described in detail above, the scope of the invention is not to be considered limited by such disclosure, and modifications are possible without departing from the spirit of the invention as evidenced by the claims:

1. A computerized method for calculating and presenting healthcare claims metrics comprising one or more computers executing instructions to:
(a) store in at least one database for a plurality of healthcare providers insurance claims interaction data for a specified period of time, the claims interaction data comprising:
(i) claims transactions processed by the insurer; and
(ii) claims inquiries to the insurer;
(b) store in a provider cross reference database for the plurality of healthcare providers:
(i) a plurality of generated healthcare system identifiers; and
(ii) for each of the plurality of generated healthcare system identifiers, a plurality of provider identifiers comprising at least:
(1) a provider name; and
(2) a provider number;
(c) receive by one of the computers a provider name for a healthcare provider;
(d) access by the computer the provider cross reference database to locate a generated healthcare system identifier associated with the provider name;
(e) locate by the computer in the provider cross reference database a plurality of provider identifiers associated with the generated healthcare system identifier;
(f) search the at least one database for insurance claims interactions associated with the plurality of provider identifiers;
(g) calculate by the computer a plurality of claims interaction metrics based on the insurance claims interactions associated with each of the plurality of provider identifiers;
(h) generate by the computer a first report comprising:
(i) the generated healthcare system identifier;
(ii) aggregated insurance claims interaction metrics for the plurality of provider identifiers; and
(iii) a first processing tip related to a claims auto-adjudication rate for the plurality of provider identifiers associated with the generated healthcare system identifier; and
(iv) a second processing tip related to a claims denial rate for the plurality of provider identifiers associated with the generated healthcare system identifier;
(i) generate by the computer an additional report for each of the plurality of providers identifiers comprising:
(i) the provider identifier;
(ii) the insurance claims interaction metrics for the provider identifier; and
(iii) a first processing tip related to a claims auto-adjudication rate for the provider identifier; and
(iv) a second processing tip related to a claims denial rate for the provider identifier; and
(j) transmit to a user computer for display at the user computer a link to:
(i) to the report for the generated healthcare system identifier; and
(ii) to each report for each of the plurality of provider identifiers.

2. The computerized method of claim 1 wherein the metrics for the claims transactions are selected from the group consisting of:
insurance claims count, dollar volume allowed by the insurer, dollar volume paid by the insurer, dollar volume paid as a percentage of dollar volume allowed, electronically submitted claim rate, initially accepted claim submission rate, paid within 21 days rate, auto-adjudicated rate, percentage of claims held, claims return rate, reprocessed rate, and financial recovery amount.

3. (canceled)

4. The computerized method of claim 1 wherein the metrics for the claims inquiries are selected from the group consisting of:
web transactions, interactive voice response system calls, telephone calls with insurer representatives, and mail transactions.

5. The computerized method of claim 1 wherein the provider number is a tax identification number.

6. (canceled)

7. (canceled)

8. A computerized system for generating and presenting healthcare claims metrics comprising:
(a) at least one database storing a plurality of healthcare providers insurance claims interaction data for a specified period of time comprising:
(i) claims transactions processed by the insurer; and
(ii) claims inquiries to the insurer;
(b) a cross reference database for the plurality of healthcare providers comprising:
(i) a plurality of generated healthcare system identifiers; and
(ii) for each of the plurality of generated healthcare system identifiers, a plurality of provider identifiers comprising at least:
(1) a provider name; and
(2) a provider number;
(c) a computer comprising instructions to:
(1) receive a provider name for a healthcare provider;
(2) access by the computer the provider cross reference database to locate a generated healthcare system identifier associated with the provider name;
(3) locate by the computer in the cross reference database a plurality of provider identifiers associated with the generated healthcare system identifier;
(4) search the at least one database for insurance claims interactions associated with the plurality of provider identifiers;
(5) calculate by the computer a plurality of claims interaction metrics based on the insurance claims interactions associated with each of the plurality of provider identifiers;
(6) generate by the computer a first report comprising:
(i) the generated healthcare system identifier;
(ii) aggregated insurance claims interaction metrics for the plurality of provider identifiers; and
(iii) a first processing tip related to a claims auto-adjudication rate for the plurality of provider identifiers associated with the generated healthcare system identifier; and
(iv) a second processing tip related to a claims denial rate for the plurality of provider identifiers associated with the generated healthcare system identifier;
(7) generate by the computer an additional report for each of the plurality of provider identifiers comprising:
(i) the provider identifier;
(ii) the insurance claims interaction metrics for the provider identifier; and
(iii) a first processing tip plurality of provider identifiers associated with the generated healthcare system identifier; and
(iv) a second processing tip related to a claims denial rate for the plurality of provider identifiers associated with the generated healthcare system identifier;
(8) transmit to a user computer for display at the user computer a link to:
(i) to the report for the generated healthcare system identifier; and
(ii) to each report for each of the plurality of provider identifiers.

9. The computerized system of claim 8 wherein the metrics for the claims transactions are selected from the group consisting of:
insurance claims count, dollar volume allowed by the insurer, dollar volume paid by the insurer, dollar volume paid as a percentage of dollar volume allowed, electronically submitted claim rate, initially accepted claim submission rate, paid within 21 days rate, auto-adjudicated rate, percentage of claims held, claims return rate, reprocessed rate, and financial recovery amount.

10. (canceled)

11. The computerized system of claim 8 wherein the metrics for the claims inquiries are selected from the group consisting of:
web transactions, interactive voice response system calls, telephone calls with insurer representatives, and mail transactions.

12. The computerized system of claim 8 wherein the provider identifier is a tax identification number.

13. (canceled)

14. (canceled)

15. A computerized method for calculating and presenting healthcare claims metrics comprising one or more computers executing instructions to:
(a) store in at least one database for a plurality of healthcare providers:
(1) insurance claims transaction data for transactions processed by an insurer over a specified period of time; and
(2) insurance claims inquiries to the insurer over the specified period of time;
(b) store in a provider cross reference database for the plurality of healthcare providers:
(i) a plurality of generated healthcare system identifiers; and
(ii) for each of the plurality of generated healthcare system identifiers, a plurality of provider identifiers comprising at least:
(1) a provider name; and
(2) a provider number;
(c) receive at one of the computers a generated healthcare system identifier;
(d) access by the computer the provider cross reference database to locate a plurality of provider identifiers associated with the generated healthcare system identifier;
(e) search the at least one database for insurance claims interactions associated with the plurality of provider identifiers;
(f) calculate by the computer a plurality of claims interaction metrics based on the insurance claims interactions transactions associated with each of the plurality of provider identifiers;
(g) generate by the computer a first report comprising:
(i) the generated healthcare system identifier;
(ii) aggregated insurance claims interaction metrics for the plurality of provider identifiers; and
(iii) aggregated insurance claims inquiries metrics comprising:
(1) for each of a plurality of inquiry methods, a total of number of inquiries in each of a plurality of inquiry categories; and
(2) for each of the plurality of inquiry methods, a percentage of inquiries for the inquiry method;
(h) generate by the computer an additional report for each of the plurality of providers comprising:
(i) the provider identifier;
(ii) the insurance claims interaction metrics for the provider identifier; and
(iii) aggregated insurance claims inquiries metrics comprising:
(1) for each of a plurality of inquiry methods, a total of number of inquiries in each of a plurality of inquiry categories; and
(2) for each of the plurality of inquiry methods, a percentage of inquiries for the inquiry method;
(i) transmit to a user computer for display at the user computer a link to:
(i) to the report for the generated healthcare system identifier; and
(ii) to each report for each of the plurality of provider identifiers.

16. The computerized method of claim 15 wherein the metrics for the claims transactions are selected from the group consisting of:
insurance claims count, dollar volume allowed by the insurer, dollar volume paid by the insurer, dollar volume paid as a percentage of dollar volume allowed, electronically submitted claim rate, initially accepted claim submission rate, paid within 21 days rate, auto-adjudicated rate, percentage of claims held, claims return rate, reprocessed rate, and financial recovery amount.

17. (canceled)

18. The computerized method of claim 15 wherein the plurality of inquiry methods are selected from the group consisting of:
web transactions, interactive voice response system calls, telephone calls with insurer representatives, and mail transactions.

19. (canceled)

20. (canceled)
